(19) United States
(12) Patent Application Publication
(10) Pub. No.: US 2019/0251100 A1
(43) Pub. Date: Aug. 15, 2019

(54) LEARNING METHOD AND LEARNING APPARATUS

(71) Applicant: FUJITSU LIMITED, Kawasaki-shi (JP)

(72) Inventors: Hiroko Suzuki, Kawasaki (JP); Isamu Watanabe, Kawasaki (JP)

(73) Assignee: FUJITSU LIMITED, Kawasaki-shi (JP)

(21) Appl. No.: 16/268,958

(22) Filed: Feb. 6, 2019

(30) Foreign Application Priority Data
Feb. 13, 2018 (JP) 2018-022708

(51) Int. Cl. G06F 16/31; G06K 9/00; G06F 16/35; G06F 16/33; G06N 20/00

(52) U.S. Cl. CPC G06F 16/313; G06K 9/00442; G06N 20/00; G06F 16/334; G06F 16/35

(57) ABSTRACT

A learning apparatus includes a processor configured to extract an item commonly included in documents of events regarding a specific target. Each of the documents includes a common phenomenon, a common cause, and items regarding the specific target. The processor is configured to rank the documents based on an appearance frequency of the extracted item. The processor is configured to assign a label of a positive example or a negative example to each of the documents based on a result of the ranking. The processor is configured to learn a model for determining whether a specific document is a positive example or a negative example using the documents and the label assigned to each of the documents. The specific document is a document of an event regarding the specific target and includes the common phenomenon, the common cause, and items regarding the specific target.

### CROSS-REFERENCE TO RELATED APPLICATION

This application is based upon and claims the benefit of priority of the prior Japanese Patent Application No. 2018-022708, filed on Feb. 13, 2018, the entire contents of which are incorporated herein by reference.

### FIELD

The embodiment discussed herein is related to a learning method and a learning apparatus.

### BACKGROUND

Market quality management after product shipment has become an important management task for manufacturers that ship various products to the market. In the market quality management, for each field failure report which is a failure report of a product released in the market, a corresponding example is determined among the known failure examples of an occurring event, a cause of the occurrence, and a countermeasure. Then, the failure in the report is dealt with by referring to the determined example.

FIG. 8 is an explanatory view illustrating a flow of a market quality management task. As illustrated in FIG. 8, in the market quality management, one failure has occurred for the products shipped to the market, and one field failure report 201 is generated for the one failure among the flow (S201) until a countermeasure is executed. In the field failure report 201, information on the failure is described in an order of, for example, an event, cause, and countermeasure.

Manufacturers shipping products to the market analyzes the trend of failure for the multiple field failure reports 201 generated as described above (S202). Further, the manufacturers confirm whether the response situation to the failure is suitable (S203) and consider whether an intensive response is necessary among mutually common examples (S204).

Among the examples common in the plurality of field failure reports 201, an example which needs an intensive response is registered as a failure example 202 in a failure example DB 203. In the market quality management, the frequently occurring failures are registered as knowledge to be used when a failure event is analyzed.

In determining the field failure reports when a failure event is investigated, a determination model is constructed by machine learning using known failure examples as right response data, and the constructed determination model is used. Therefore, a failure example to which each field failure report corresponds is effectively specified with high precision, so that a prompt response to the failure is implemented.

The number of known failure examples which are used as right response data in the machine learning is small. Thus, in order to construct the determination model with a high precision, there has been used a method of manually attaching labels such as a positive example and a negative example to the field failure reports. However, this method increases the load of manual labor.

As for a learning method which performs the learning by attaching the labels without using the manual labor, there has been known a learning method that classifies an example into a positive example when a score calculated using all element values of a feature included in the data to be classified and an importance set included in learning result information is high.

Related techniques are disclosed in, for example, Japanese Laid-open Patent Publication No. 2015-001968, Japanese Laid-open Patent Publication No. 2013-131073, Japanese Laid-open Patent Publication No. 2006-031213, and Japanese Laid-open Patent Publication No. 2006-099565.

### SUMMARY

According to an aspect of the present invention, provide is a learning apparatus including a memory and a processor coupled to the memory. The processor is configured to extract an item commonly included in documents of events regarding a specific target. Each of the documents includes a common phenomenon, a common cause, and items regarding the specific target. The processor is configured to rank the documents based on an appearance frequency of the extracted item. The processor is configured to assign a label of a positive example or a negative example to each of the documents based on a result of the ranking. The processor is configured to learn a model for determining whether a specific document is a positive example or a negative example using the documents and the label assigned to each of the documents. The specific document is a document of an event regarding the specific target and includes the common phenomenon, the common cause, and items regarding the specific target.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is an explanatory view for explaining a determination of a field failure report;

FIG. 2 is an explanatory view illustrating a failure example;

FIG. 3 is an explanatory view illustrating a field failure report;

FIG. 4 is a block diagram illustrating an example of a functional configuration of an information processing apparatus according to an embodiment;

FIG. 5 is a flowchart illustrating an example of an operation of a learning phase;

FIG. 6 is a flowchart illustrating an example of an operation of an applying phase;

FIG. 7 is an explanatory view illustrating an example of a computer which executes a program; and

FIG. 8 is an explanatory view illustrating a flow of a market quality management task.

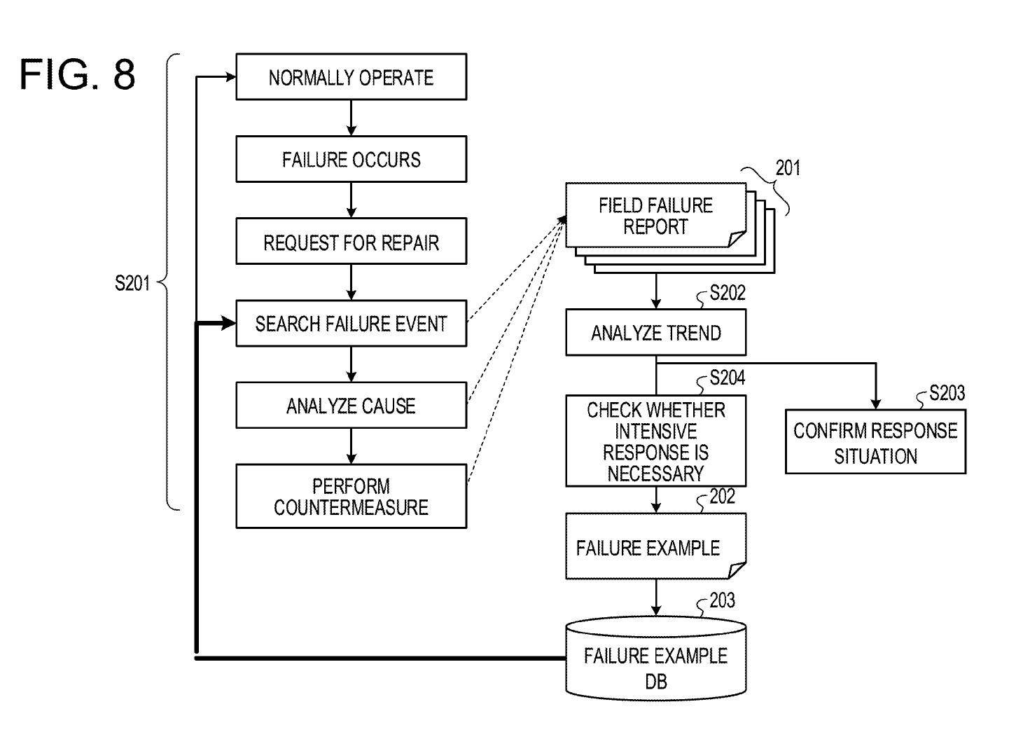

### DESCRIPTION OF EMBODIMENT

In the related art described above, for example, since the failure report having a low score is not attached with a label and is not used for the machine learning, the determination precision of the model may be insufficient.

Hereinafter, an embodiment will be described with reference to the accompanying drawings. In the embodiment, components having the same function will be denoted by the same reference numerals, and overlapping description thereof will be omitted. Further, the following embodiment is merely an example and does not limit the embodiment.

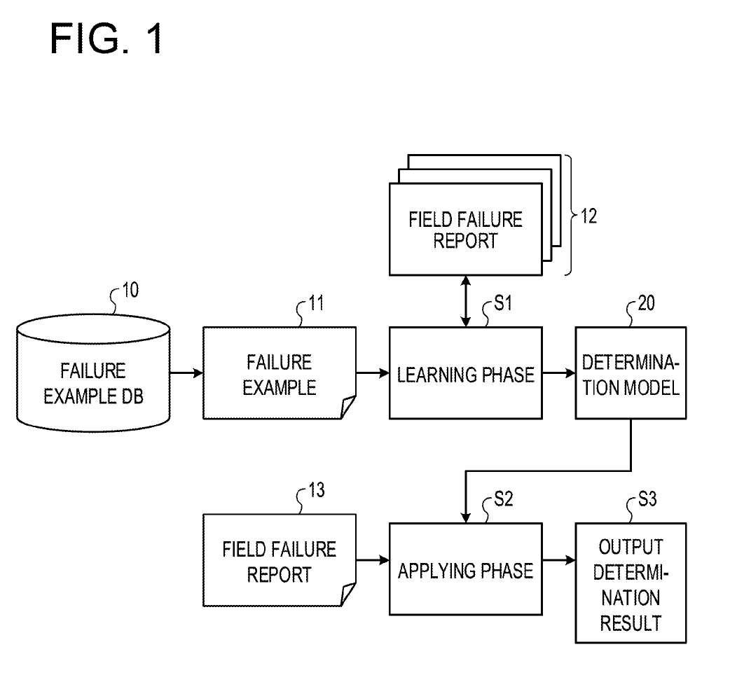

FIG. 1 is an explanatory view for explaining a determination of a field failure report. As illustrated in FIG. 1, in a learning phase S1, a known failure example 11 in a failure example DB 10 is used as right response data, and a determination model 20 that determines whether a field failure report 13 to be determined corresponds to the failure example 11 by using a general binary classification machine learning method is learned.

Here, in the learning phase S1, the labels of a positive example and a negative example are assigned to the plurality of field failure reports 12 using the failure example 11 used as right response data. Then, the field failure reports 12 to which the labels are assigned are added as teacher data (training data) for learning the determination model 20. In this way, the field failure reports 12 to which the labels of a positive example and a negative example are assigned are added to the teacher data at the time of learning the determination model 20 to increase the number of samples of teacher data, thereby increasing the determination precision of the determination model 20.

In an applying phase S2, it is determined whether an individual field failure report 13 to be determined corresponds to the failure example 11, by applying the learned determination model 20 to the field failure report 13. In S3, the determination result of the applying phase is output to, for example, a display.

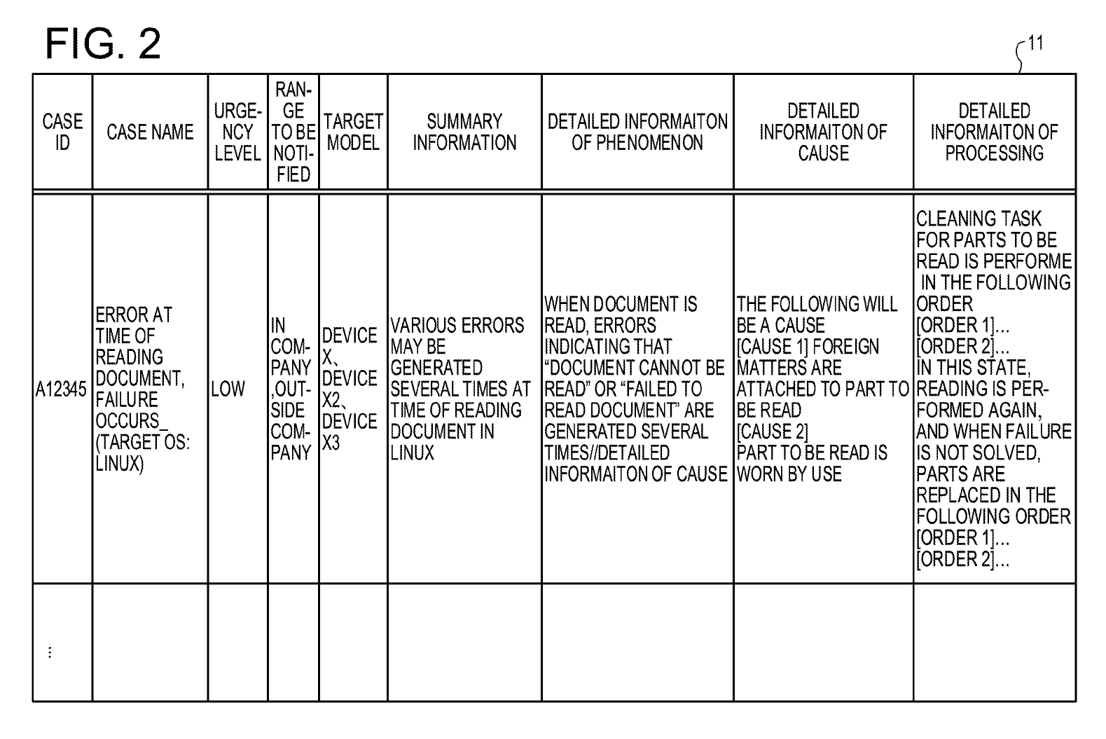

FIG. 2 is an explanatory view illustrating the failure example 11. As illustrated in FIG. 2, the failure example 11 is a known example after a tendency of a failure is analyzed, and is a document including a plurality of items relating to a phenomenon, a cause, and a target. Specifically, the failure example 11 includes information such as an “example name,” an “urgency level,” a “range to be notified,” a “target model,” “summary information,” “detailed information of phenomenon,” “detailed information of cause,” and “detailed information of countermeasure” for each “example ID” which identifies an example.

The “example name” refers to a name of an example. The “urgency level” indicates an urgency degree of a countermeasure in the example. The “range to be notified” refers to a range where the example is to be notified (e.g., a company or outside a company). The “target model” refers to a model of a product which is a target of the example. The “summary information” refers to the summary of the example. The “detailed phenomenon information” specifically represents the phenomenon of the example. The “detailed cause information” specifically represents the cause of the example. The “detailed information of countermeasure” specifically represents the countermeasure taken in the example.

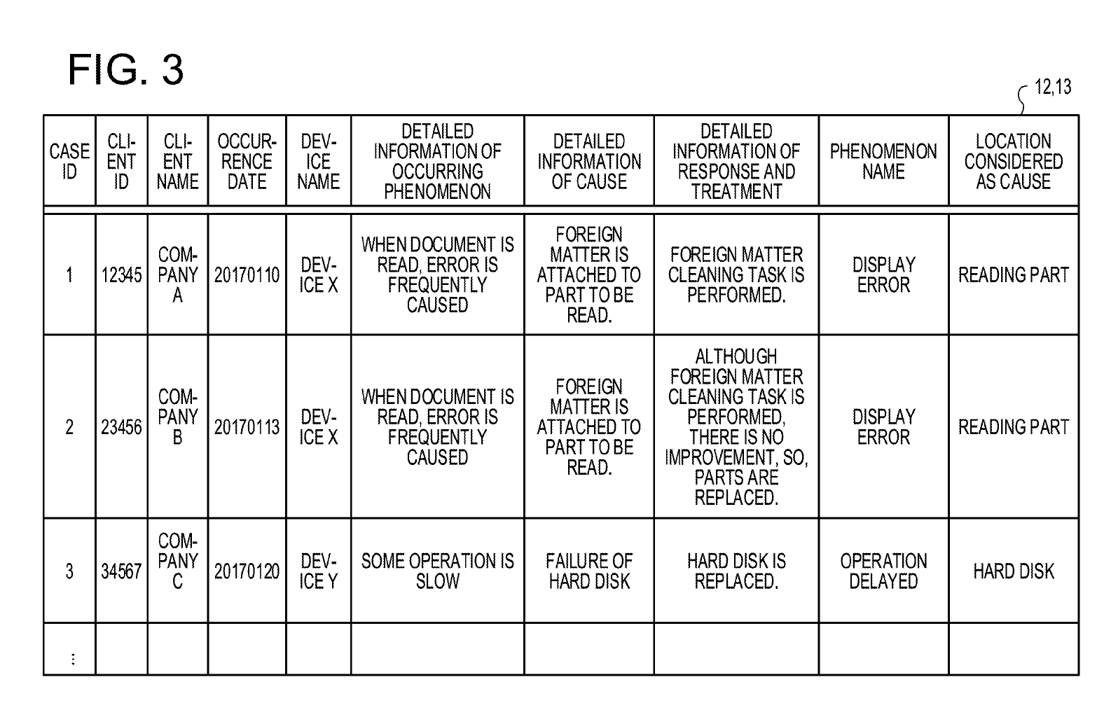

FIG. 3 is an explanatory view illustrating the field failure reports 12 and 13. As illustrated in FIG. 3, a field failure report is a document which describes contents of one failure from an occurrence of the failure until a performance of a countermeasure, and includes multiple items relating to a phenomenon, a cause, and a target as in the failure example 11. Specifically, each of the field failure reports 12 and 13 includes information such as a “client ID,” a “customer name,” an “occurrence date,” a “device name”,” “detailed information of occurring phenomenon,” “detailed information of cause,” “detailed information of countermeasure,” a “phenomenon name,” and a “location considered as a cause” for each “issue ID” which identifies an issue of a failure.

The “client ID” is an ID for identifying a client. The “client name” refers to a name of the client. The “occurrence date” refers to a date when a failure occurs. The “device name” refers to a name of a device related to the failure. The “detailed information of occurring phenomenon” specifically represents the phenomenon of the failure. The “detailed information of cause” specifically represents the cause of the failure. The “detailed information of countermeasure” specifically represents response and treatment for the failure. The “phenomenon name” refers to a name of the phenomenon of the failure. The “location considered as a cause” refers to a location which becomes a cause of the failure.

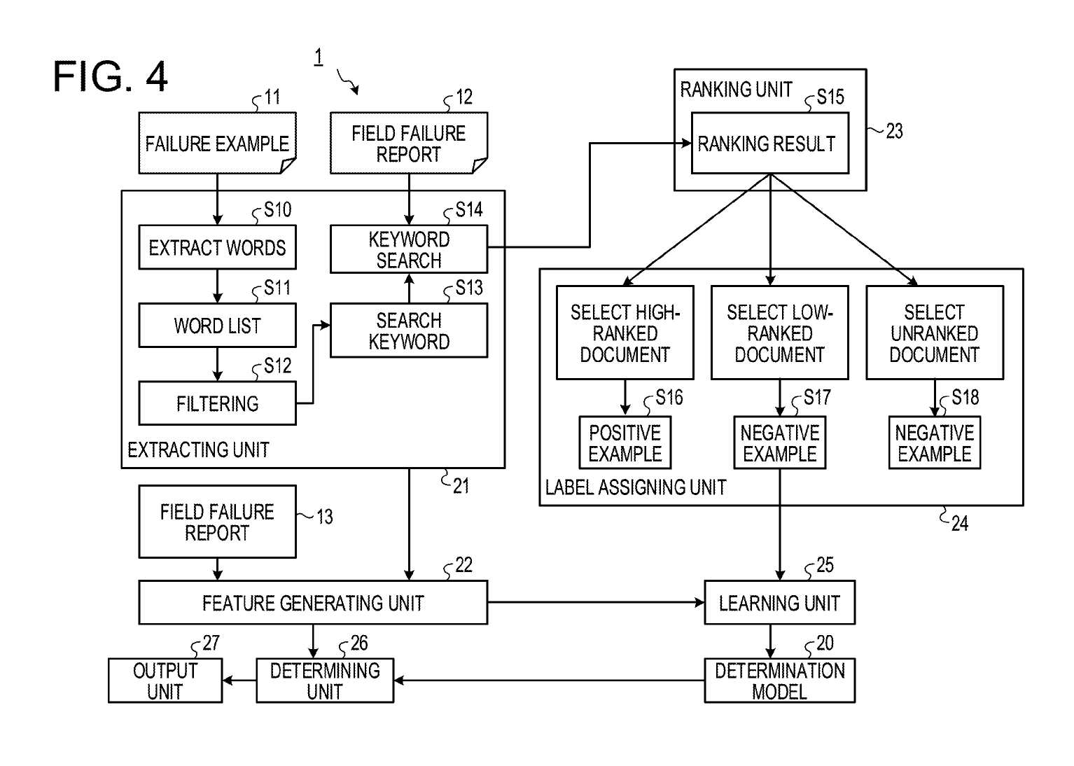

FIG. 4 is a block diagram illustrating an example of a functional configuration of an information processing apparatus according to an embodiment. For example, an information processing apparatus 1 according to the embodiment is a computer such as a personal computer (PC) and executes the learning phase S1 and the applying phase S2 illustrated in FIG. 1. That is, the information processing apparatus 1 is an example of a learning apparatus.

As illustrated in FIG. 4, the information processing apparatus 1 includes an extracting unit 21, a feature generating unit 22, a ranking unit 23, a label assigning unit 24, a learning unit 25, a determining unit 26, and an output unit 27.

The extracting unit 21 extracts an item common between documents, with respect to a plurality of failure examples 11 having a common phenomenon and cause among known failure examples 11 stored in the failure example DB 10. In the known failure examples 11 used as right response data in the learning phase, for the same issue having common phenomenon and cause, there are some variations due to, for example, a different OS.

The extracting unit 21 groups the failure examples 11 related to the same issue having common phenomenon and cause, among the failure examples 11 stored in the failure example DB 10. Then, the extracting unit 21 extracts an item common between documents for each group.

Specifically, the extracting unit 21 extracts words included in the failure examples 11 as an example of the item (S10). In the embodiment, words are extracted as an example. However, the item to be extracted is not limited to words. For example, the item to be extracted may be not only sentences/phrases included in the failure examples 11 but also, for example, a sub-item obtained by itemization in, for example, the detailed information included in the failure examples 11.

Subsequently, the extracting unit 21 generates a word list of the extracted words (S11), and performs a filtering process to delete words, except for words common in the groups, among the words included in the word list (S12). The extracting unit 21 obtains the word common in the group (search keyword) by the filtering process (S13). Subsequently, the extracting unit 21 performs a keyword search of the field failure reports 12 using the search keyword (S14).

The feature generating unit 22 generates a feature representing characteristics of the failure examples 11 or the field failure reports 12 which are used as teacher data in the learning phase. Further, the feature generating unit 22 generates a feature representing a characteristic of the field failure report 13 which is applied to the determination model 20 in the applying phase. For example, the feature generating unit 22 generates an appearing word vector in the failure examples 11 and the field failure reports 12 and 13 as a feature, based on the words extracted from the failure examples 11 and the field failure reports 12 and 13.

The appearing word vector is calculated based on co-occurrence words which co-occur before and after a word to be subjected to the calculation of the appearing word vector, and is configured by a plurality of vector components corresponding to the co-occurrence words. For example, in a specific failure example 11, co-occurrence words of a word “motion” may be highly likely to be, for example, “at the time of reading” and “frequent.” In the failure example case 11, among the plurality of vector components included in the word vector of the word “motion,” values corresponding to the components of “at the time of reading” and “frequent” tend to increase. Further, in another failure example 11, the co-occurrence words of the word “motion” may be highly likely to be, for example, “partial” and “late.” In the failure example 11, among the plurality of vector components included in the word vector of the word “motion,” values corresponding to the components of “partial” and “late” tend to increase. In this way, the feature generating unit 22 generates a feature (appearing word vector) representing characteristics of the failure examples 11 and the field failure reports 12 and 13.

The feature generated by the feature generating unit 22 is not limited to the appearing word vector, but may be, for example, information such as a characteristic vector representing a characteristic of a document without being specifically limited.

The ranking unit 23 ranks the plurality of field failure reports 12 based on the appearance frequency of the extracted item (search keyword) in the field failure reports 12. Specifically, based on the result of the keyword search (S14), the ranking unit 23 obtains a ranking result in which the field failure reports 12 are ranked in a descending order of the appearance frequency of the search keyword (S15).

The label assigning unit 24 assigns the label of a positive example or a negative example to each of the plurality of field failure reports 12 according to the ranking result (S14) of the ranking unit 23. Specifically, the label assigning unit 24 selects a high-ranked field failure report 12 whose ranking result is a predetermined or higher rank, and assigns the label of a positive example to the selected field failure report 12 (S16). Further, the label assigning unit 24 selects a low-ranked or unranked field failure report 12 whose ranking result is a predetermined or lower rank or out of rank, and assigns the label of a negative example to the selected field failure report 12 (S17 and S18).

The learning unit 25 uses the field failure reports 12 and the labels assigned thereto, in addition to the failure examples 11 used as right response data, to learn the determination model 20 that determines whether the field failure report to be determined corresponds to the failure examples 11 using the general binary classification machine learning method. Specifically, the learning unit 25 uses the failure examples 11 which are right response data, as teacher data, to learn the determination model 20 based on the feature generated in the failure examples 11. Further, the learning unit 25 learns the determination model 20 by using the field failure reports 12 to which the labels of a positive example and a negative example are assigned, as the teacher data at the time of learning the determination model 20.

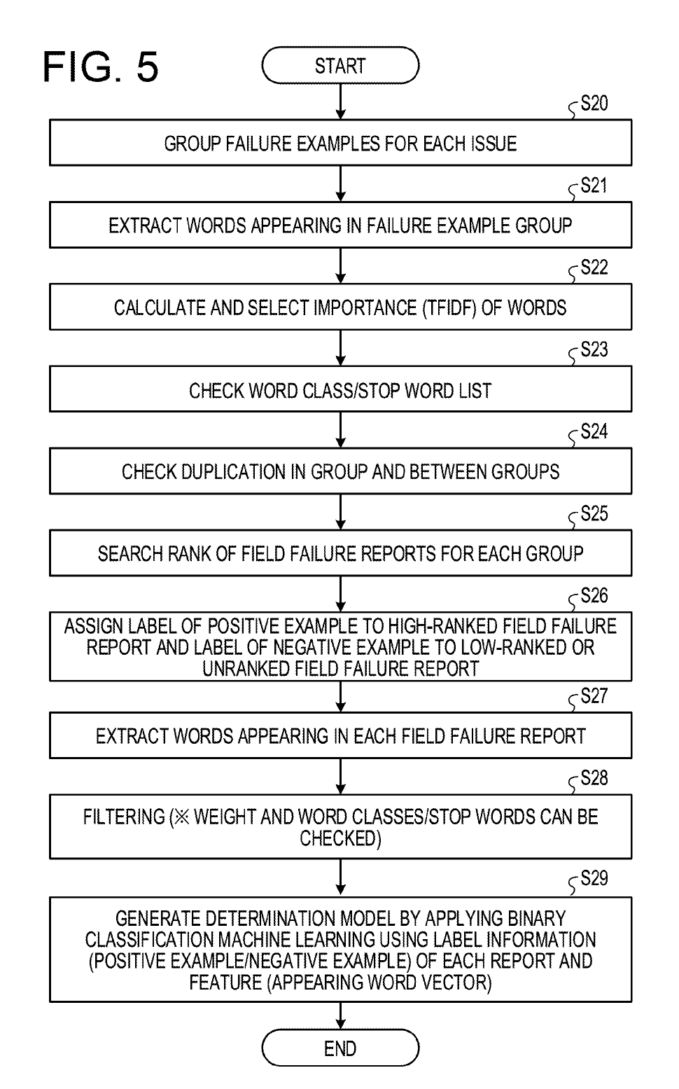

Here, in the learning phase S1, details of the processes performed in the extracting unit 21, the feature generating unit 22, the ranking unit 23, the label assigning unit 24, and the learning unit 25 will be described. FIG. 5 is a flowchart illustrating an example of the operation of the learning phase.

As illustrated in FIG. 5, when the learning phase starts, the extracting unit 21 groups the failure examples 11 included in the failure example DB 10 for each same issue having common phenomenon and cause (S20). Specifically, the extracting unit 21 groups the failure examples 11 which are identical to each other (including a high similarity) in “detailed information of phenomenon” and “detailed information of cause” into failure examples related to the same issue.

Subsequently, the extracting unit 21 extracts words appearing in a group of the grouped failure examples 11 (S21). Accordingly, the extracting unit 21 generates a word list of the extracted words. Subsequently, the extracting unit 21 calculates an importance (term frequency/inverse document frequency (TFIDF)) of the extracted words, and selects a word having a relatively high importance from the word list (S22). Then, the extracting unit 21 deletes the unselected words from the word list.

Subsequently, the extracting unit 21 checks a word class/stop word list, and deletes word classes/stop words that correspond to the list, from the word list (S23). The word classes/stop words included in the word class/stop word list may be generally included in, for example, any document. The word classes are, for example, postpositional particles and auxiliary verbs. The stop words are, for example, “do,” “thing,” “when,” “occurrence,” and “failure.”

Subsequently, the extracting unit 21 checks duplication of the words included in the word list within the corresponding group or among the groups (S24). As a result, the extracting unit 21 obtains a common word as a search keyword.

Subsequently, the extracting unit 21 performs a keyword search of the field failure reports 12 for each group using the search keyword. Therefore, the appearance frequency of the search keyword is requested for the field failure reports 12. Subsequently, the ranking unit 23 performs a ranking search to rank the field failure reports 12 in the descending order of appearance frequency of the search keyword (S25).

Subsequently, the label assigning unit 24 assigns the label of a positive example to the high-ranked field failure report 12 which is in a predetermined or higher rank, based on the ranking search. Further, the label assigning unit 24 assigns the label of a negative example to the low-ranked/unranked field failure report 12 which is in a predetermined or lower rank (S26).

Subsequently, the feature generating unit 22 extracts appearing words from each field failure report 12 (S27). Subsequently, the feature generating unit 22 performs the filtering process on the extracted words to delete words which are unnecessary to generate the feature (S28). The feature generating unit 22 generates a feature (e.g., appearing word vector) using the filtered words.

In the filtering process, the feature generating unit 22 may perform, for example, a process of assigning an importance to the extracted words according to a predetermined condition and deleting words having a lower weight. Further, based on a predetermined word class/stop word list, the feature generating unit 22 checks whether the extracted words correspond to the word classes/stop words in the list. Subsequently, the feature generating unit 22 may delete the words (word classes/stop words) corresponding to the list.

Subsequently, the learning unit 25 applies the binary classification machine learning using the label information (positive example/negative example) assigned to each field failure report 12 and the generated feature (appearing word vector), to generate the determination model 20 (S29).

Referring back to FIG. 4, the determining unit 26 applies the feature (e.g., the appearing word vector) generated by the feature generating unit 22 to the determination model 20, to determine whether the field failure report 13 to be determined corresponds to the known failure example 11. The output unit 27 outputs a determination result of the determining unit 26.

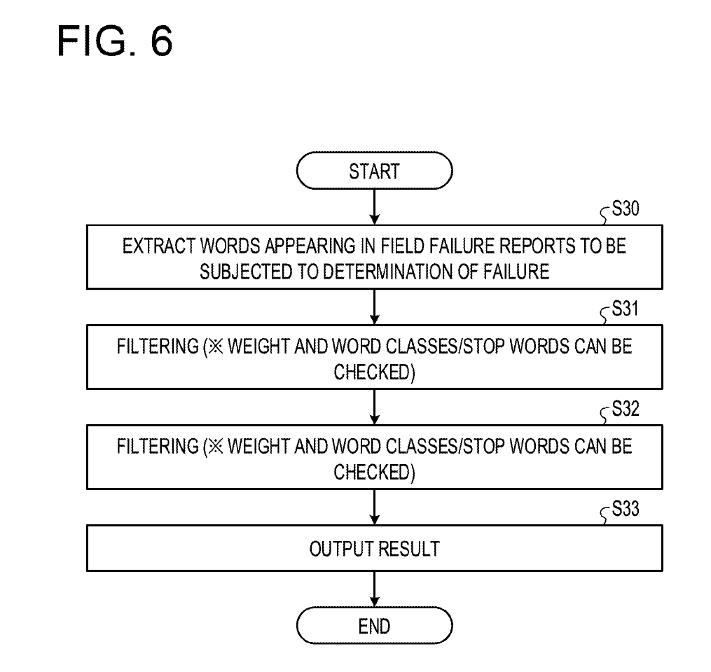

Here, details of the processes performed by, for example, the feature generating unit 22, the determining unit 26, and the output unit 27 in the applying phase S2 will be described. FIG. 6 is a flowchart illustrating an example of the operation of the applying phase.

As illustrated in FIG. 6, when the applying phase starts, the feature generating unit 22 extracts words appearing in the field failure report 13 to be subjected to the determination of a failure (S30). Subsequently, the feature generating unit 22 performs the filtering process on the extracted words (S31). The filtering process may be the same as that in S28.

Subsequently, the feature generating unit 22 generates a feature (e.g., appearing word vector) using the filtered words. Subsequently, the determining unit 26 applies the determination model 20 obtained in the learning phase using the generated feature of the field failure report 13, to determine whether the field failure report 13 corresponds to the known failure example 11 (S32). Subsequently, the output unit 27 outputs a result of the determination of whether the field failure report 13 to be determined corresponds to the known failure example 11 (S33). Therefore, the user may confirm whether the field failure report 13 corresponds to the known failure example 11.

As described above, with respect to the plurality of failure examples 11 having common phenomenon and cause among the plurality of failure examples 11 of the specific target to be learned by the determination model 20 that determines the field failure report 13, the information processing apparatus 1 extracts an item common between the corresponding failure examples 11. Further, the information processing apparatus 1 ranks the plurality of field failure reports 12 based on the appearance frequency of the extracted item in the field failure reports 12. Further, the information processing apparatus 1 assigns the label of a positive example or a negative example to each of the plurality of field failure reports 12 according to the ranking result. Further, the information processing apparatus 1 learns the determination model 20 using the field failure reports 12 and the labels assigned thereto, in addition to the failure examples 11 which are right response data.

The documents of the failure field (e.g., the known failure examples 11 or the field failure reports 12 and 13) each have a structure having multiple items relating to a phenomenon, a cause, and a target. Further, in the known failure examples 11 used as right response data, for the same issue having common phenomenon and cause, there are some variations due to, for example, a different OS.

Focusing on these properties, the information processing apparatus 1 extracts an item common between the failure examples 11, for each of the plurality of failure examples 11 having the common phenomenon and cause. In this way, the information processing apparatus 1 performs the filtering by using the relationship among the plurality of failure examples 11 having the common phenomenon and cause, and thus, excludes the general item related to the reason of the difference in OS. Further, the information processing apparatus 1 uses the plurality of field failure reports 12 to learn the determination model 20 by ranking the respective field failure reports 12 according to the appearance frequency of the extracted item in the field failure reports 12 and assigning the labels of a positive example and a negative example according to the ranking. In this way, the information processing apparatus 1 efficiently adds the field failure reports 12 which are appropriate to be considered as positive examples or negative examples to the teacher data (training data), to perform the learning with a teacher in the determination model 20, thereby improving the determination precision of the determination model 20.

Here, the improvement of the determination precision of the determination model 20 in the information processing apparatus 1 is represented by experimental examples in first to third cases.

The first case is an experimental example where sufficient positive examples and negative examples are prepared (where right response labels (positive examples/negative examples) are assigned to the field failure reports 12 by the manual labor, and are learned/applied, for comparison and verification). In the first case, since the right response labels (positive examples/negative examples) are assigned to many field failure reports 12 to be learned without considering the load by the manual labor, the determination precision is high.

First case: Number of samples of training data: positive examples=186, negative examples=39,000, Precision=98.8%, and Recall=86.0%

The second case is an experimental example in a case where one class support vector machine (SVM) is used. Second case: Number of samples of training data: positive examples=3, negative examples=0, Precision=0.6%, and Recall=67.2%

The third case is an experimental example in a case where the information processing apparatus 1 according to the embodiment is used. Third case: Number of samples of training data: positive examples=3, negative examples=0, right responses added to the examples above: positive examples=5, negative examples=10,000, Precision=54.8%, and Recall=12.1%

As apparent from the comparison between the second case and the third case, in the third case, the field failure reports 12 which are appropriate to be considered as the positive examples or negative examples are added to the training data so that the determination precision is improved as compared with the second case.

The information processing apparatus 1 extracts a common item among narrowed items, based on a weight according to the appearance frequency for each item included in the failure examples 11. The item whose appearance frequency is calculated in order to assign the positive example or the negative example may be an item which appropriately expresses the characteristic of each failure example 11. Further, a general item which is likely to exist in any documents may not be included. In the information processing apparatus 1, items are narrowed based on the weight according to the appearance frequency so that a general item which appears in many failure examples 11 is excluded in advance. Therefore, more characteristic items in the failure examples 11 may be used.

The information processing apparatus 1 assigns the label of a negative example to the field failure reports 12 whose ranking result is a predetermined or lower rank. Therefore, the information processing apparatus 1 may appropriately assign the label of a negative example to the field failure reports 12 which are not related to the failure examples 11.

Each component of the respective illustrated devices is not necessarily required to be configured physically as illustrated. That is, a specific form of distribution or integration of the respective devices is not limited to those illustrated, and all or some of the devices may be configured to be functionally or physically distributed or integrated in arbitrary units according to, for example, various loads or usage situations.

The various processing functions performed by the information processing apparatus 1 may be entirely or arbitrarily partially executed on a CPU (or a microcomputer such as an MPU or micro controller unit (MCU)). Further, the various processing functions may be entirely or arbitrarily partially executed on a program which is interpreted or executed by a CPU (or a microcomputer such as an MPU or an MCU) or on hardware by a wired logic. Further, the various processing functions performed by the information processing apparatus 1 may be executed by cooperation of a plurality of computers, by the cloud computing.

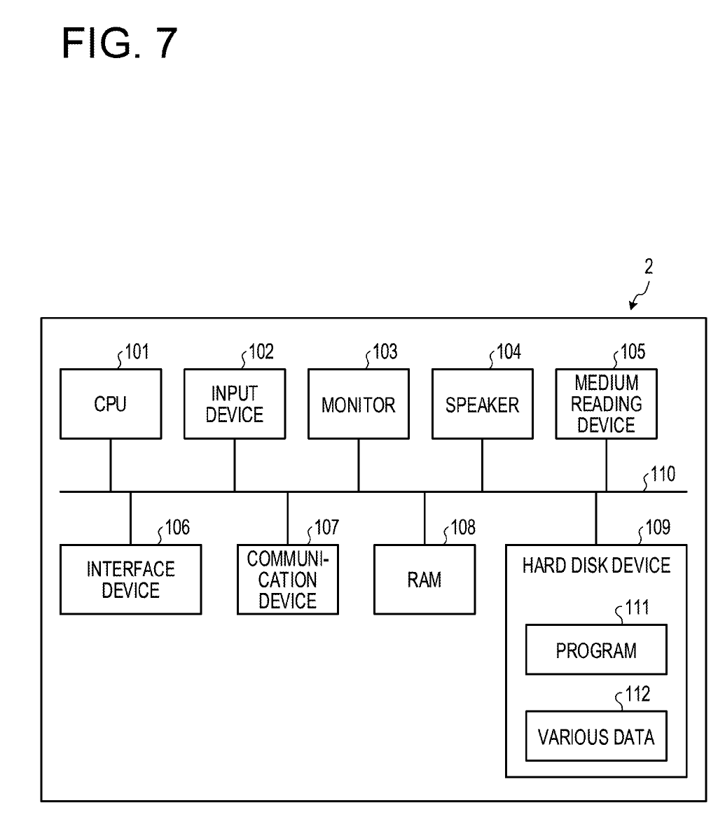

However, the various processings described in the above-described embodiment may be implemented by executing a predetermined program by a computer. Therefore, hereinafter, an example of the computer (hardware) which executes a program having the same function as the above-described embodiment will be described. FIG. 7 is an explanatory view illustrating an example of the computer which executes the program.

As illustrated in FIG. 7, a computer 2 includes a CPU 101 that performs various arithmetic processings, an input device 102 that receives a data input, a monitor 103, and a speaker 104. Further, the computer 2 includes a medium reading device 105 that reads out, for example, a program from a storage medium, an interface device 106 for a connection to various devices, and a communication device 107 that communicates with an external device wirely or wirelessly. Further, the computer 2 includes a RAM 108 that temporally stores various pieces of information, and a hard disk device 109. Further, respective units 101 to 109 in the computer 2 are connected to a bus 110.

In the hard disk device 109, a program 111 for executing various processings in the functional units such as the extracting unit 21, the feature generating unit 22, the ranking unit 23, the label assigning unit 24, the learning unit 25, the determining unit 26, and the output unit 27 described in the above embodiment is stored. Further, in the hard disk device 109, various data 112 which is referred by the program 111 is stored. For example, the input device 102 receives an input of manipulation information from an operator of the computer 2. For example, the monitor 103 displays various screens manipulated by the operator. For example, a printing device is connected to the interface device 106. The communication device 107 is connected to a communication network such as a local area network (LAN) to exchange various pieces of information with an external device through the communication network.

The CPU 101 reads out the program 111 stored in the hard disk device 109 to load the program in the RAM 108 and execute the program, to perform various processings for the extracting unit 21, the feature generating unit 22, the ranking unit 23, the label assigning unit 24, the learning unit 25, the determining unit 26, and the output unit 27. Further, the program 111 may not be stored in the hard disk device 109. For example, the program 111 stored in a storage medium readable by the computer 2 may be read and executed by the computer 2. The storage medium readable by the computer 2 may include a portable recording medium such as a CD-ROM, a DVD, or a universal serial bus (USB) memory or a semiconductor memory such as a flash memory, or a hard disk drive. Further, the program 111 may be stored in a device connected to, for example, a public line, the Internet, or a LAN, and the computer 2 may read and execute the program 111 stored in the device.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process, the process comprising:
extracting an item commonly included in documents of events regarding a specific target, wherein each of the documents includes a common phenomenon, a common cause, and items regarding the specific target;
ranking the documents based on an appearance frequency of the extracted item;
assigning a label of a positive example or a negative example to each of the documents based on a result of the ranking; and
learning a model for determining whether a specific document is a positive example or a negative example using the documents and the label assigned to each of the documents, wherein the specific document is a document of an event regarding the specific target and includes the common phenomenon, the common cause, and items regarding the specific target.

2. The non-transitory computer-readable recording medium according to claim 1, the process further comprising:
extracting the item commonly included in the documents from among items narrowed by weighting in accordance with an appearance frequency of each item in each of the documents.

3. The non-transitory computer-readable recording medium according to claim 1, the process further comprising:
assigning the label of a negative example to a document that is ranked at a predetermined rank or lower.

4. A learning method comprising:
extracting, by a computer, an item commonly included in documents of events regarding a specific target, wherein each of the documents includes a common phenomenon, a common cause, and items regarding the specific target;
ranking the documents based on an appearance frequency of the extracted item;
assigning a label of a positive example or a negative example to each of the documents based on a result of the ranking; and
learning a model for determining whether a specific document is a positive example or a negative example using the documents and the label assigned to each of the documents, wherein the specific document is a document of an event regarding the specific target and includes the common phenomenon, the common cause, and items regarding the specific target.

5. The learning method according to claim 4, further comprising:
extracting the item commonly included in the documents from among items narrowed by weighting in accordance with an appearance frequency of each item in each of the documents.

6. The learning method according to claim 4, further comprising:
assigning the label of a negative example to a document that is ranked at a predetermined rank or lower.

7. A learning apparatus comprising:
a memory; and
a processor coupled to the memory and the processor configured to:
extract an item commonly included in documents of events regarding a specific target, wherein each of the documents includes a common phenomenon, a common cause, and items regarding the specific target;
rank the documents based on an appearance frequency of the extracted item;
assign a label of a positive example or a negative example to each of the documents based on a result of the ranking; and
learn a model for determining whether a specific document is a positive example or a negative example using the documents and the label assigned to each of the documents, wherein the specific document is a document of an event regarding the specific target and includes the common phenomenon, the common cause, and items regarding the specific target.

8. The learning apparatus according to claim 7, wherein
the processor is further configured to:
extract the item commonly included in the documents from among items narrowed by weighting in accordance with an appearance frequency of each item in each of the documents.

9. The learning apparatus according to claim 7, wherein
the processor is further configured to:
assign the label of a negative example to a document that is ranked at a predetermined rank or lower.
